(19) United States
(12) Patent Application Publication
(10) Pub. No.: US 2018/0117872 A1
(43) Pub. Date: May 3, 2018

(54) INTERPENETRATING PHASE COMPOSITE STRUCTURES INCLUDING TRIPLY PERIODIC MINIMAL SURFACES AND METHODS OF FORMING THE SAME

(71) Applicant: Khalifa University of Science and Technology, Abu Dhabi (AE)

(72) Inventors: Rashid Abu Al-Rub, Abu Dhabi (AE); Oraib Al-Ketan, Abu Dhabi (AE)

(21) Appl. No.: 15/819,277

(22) Filed: Nov. 21, 2017

Related U.S. Application Data
(60) Provisional application No. 62/416,749, filed on Nov. 3, 2016.

(51) Int. Cl. B32B 3/12; H01M 4/02

(52) U.S. Cl. CPC B32B 3/12; H01M 4/02; B32B 2305/02; G10K 11/162; B32B 2307/206; B32B 2307/10; B32B 2307/304

(57) ABSTRACT

Interpenetrating phase composite (IPC) structures including triply periodic minimal surfaces and methods of forming the IPC structures are provided. The IPC structures may include unit cells connected to each other and arranged in three-dimensions. Each of the unit cells may include an IPC that consists of a first portion having a first volume and a second portion having a second volume. The first portion of the IPC may be substantially filled with a reinforcing material. A surface of the reinforcing material facing the second portion of the IPC may be a triply periodic minimal surface. A first one of the unit cells has a first ratio of the first volume to the second volume, a second one of the unit cells has a second ratio of the first volume to the second volume, and the first ratio and the second ratio may be different from each other.

### RELATED APPLICATION

This application claims the benefit of U.S. Provisional Patent Application Ser. No. 62/416,749, filed on Nov. 22, 2016, the disclosure of which is incorporated by reference herein in its entirety.

### FIELD OF THE INVENTION

This present invention relates to Interpenetrating Phase Composite (IPC) structures including a Triply Periodic Minimal Surface (TPMS) along with methods of forming and using the same.

### BACKGROUND

Interpenetrating phase composites (IPCs) are composites with co-continuous phases (e.g., a matrix phase and a reinforcement phase) that interpenetrate each other in such a way that if one of the phases is removed, the remaining phase will form a self-supporting cellular structure.

IPCs are uniquely different from traditional composites including a matrix with one or more reinforcing filler phases (e.g., long fibers, whiskers, particles, and micro-balloons) in which a complete interpenetration does not exist. Consequently, each phase of an IPC contributes its property to the overall macro scale characteristics synergistically. For example, if one constituent provides strength and toughness, the other might enhance stiffness, thermal stability, acoustic insulation and/or dielectric characteristics.

### SUMMARY

According to some embodiments of the present invention, functionally graded interpenetrating phase composite structures are provided. The functionally graded interpenetrating phase composite structures may include a plurality of unit cells that are connected to each other and are arranged in three-dimensions. Each of the plurality of unit cells may include an interpenetrating phase composite that is consist of a first portion having a first volume and a second portion having a second volume. The first portion of the interpenetrating phase composite may be substantially filled with a reinforcing material. A surface of the reinforcing material facing the second portion of the interpenetrating phase composite may be a triply periodic minimal surface. A first one of the plurality of unit cells has a first ratio of the first volume to the second volume, a second one of the plurality of unit cells has a second ratio of the first volume to the second volume, and the first ratio and the second ratio may be different from each other.

According to some embodiments of the present invention, functionally graded interpenetrating phase composite structures are provided. The functionally graded interpenetrating phase composite structures may include a plurality of unit cells that are connected to each other and are arranged in three-dimensions. Each of the plurality of unit cells may include an interpenetrating phase composite that includes a reinforcement phase having a curved body that divides each of the of the plurality of unit cells into a first space and a second space. The reinforcement phase may include opposing surfaces that both define a same triply periodic minimal surface pattern. The curved body of a first one of the plurality of unit cells has a first thickness, and the curved body of a second one of the plurality of unit cells has a second thickness that may be different from the first thickness.

### BRIEF DESCRIPTION OF THE DRAWINGS

FIG. 1 illustrates a unit cell of an interpenetrating phase composite (IPC) structure according to some embodiments of the present invention.

FIG. 2 illustrates an IPC structure including the unit cell of FIG. 1.

FIG. 3 illustrates a portion of a functionally graded IPC structure.

FIG. 4 illustrates a unit cell and an IPC structure including the unit cell according to some embodiments of the present invention.

FIG. 5 illustrates examples of triply period minimal surfaces (TPMSs).

FIG. 6 illustrates examples of TPMSs and unit cells including the TPMSs.

FIG. 7 represents two strategies for creating IPC structures.

FIG. 8 represents methods of forming IPC structures.

FIG. 9 illustrates examples of a unit cell of TPMS-based IPCs.

FIG. 10 illustrates TPMSs and IPC structures including the TPMSs.

FIG. 11 is graphs of stress-strain curves of IPCs.

FIGS. 12, 13 and 14 are graphs of mechanical properties of IPCs.

FIG. 15 represents a process of forming a jet engine bracket according to some embodiments of the present invention.

FIG. 16 illustrates sandwich panels with TPMS-based IPC cores according to some embodiments of the present invention.

FIG. 17 illustrates a functionally graded IPC.

FIG. 18 illustrates an IPC including two reinforcement phases.

FIG. 19 illustrates a battery including an interpenetrating phase cathode.

### DETAILED DESCRIPTION

“Minimal surface” refers to a surface that locally minimizes its area such that the mean curvature at each point on the surface is zero.

“Mean curvature” refers to the average of the two principal curvatures.

“Principal curvatures” refers to the maximum and minimum of the normal curvatures at a specific point.

“Triply periodic minimal surface” (TPMS) refers to a minimal surface including a unit cell that can be repeated in three directions. If it has no self-intersections, it divides a space into two or more interpenetrating meandering spaces. A triply periodic minimal surface with no self-intersections splits a space in two entangled spaces. The two spaces separated by a triply periodic minimal surface may be either identical or non-identical.

“Functional grading” refers to gradually changing a volume fraction of one of phases of an IPC to change properties (e.g., mechanical, physical, chemical, optical, magnetic properties) of the IPC.

“Volume fraction” refers a ratio of a volume of one of phases of an IPC to the total volume of the IPC.

Like numbers refer to like elements throughout. In the figures, the thickness of certain lines, layers, components, elements or features may be exaggerated for clarity.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise.

According to some embodiments of the present invention, interpenetrating phase composite structures are provided. The interpenetrating phase composite structures may include unit cells that are connected to each other and are arranged in three-dimensions.

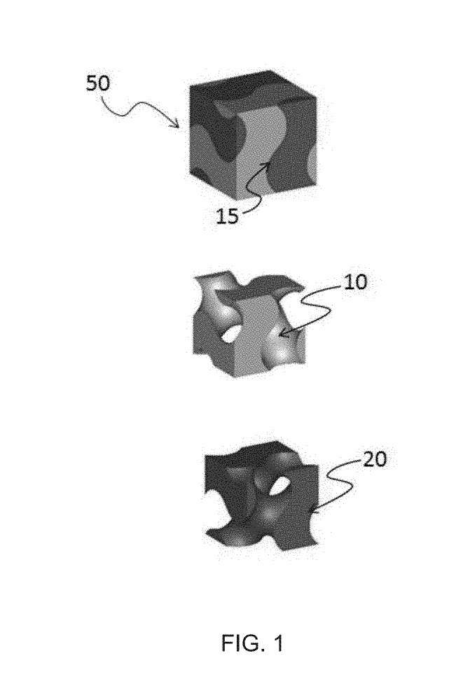

FIG. 1 illustrates a unit cell of an interpenetrating phase composite (IPC) structure according to some embodiments of the present invention. Referring to FIG. 1, a unit cell 50 may include a first portion 10 and a second portion 20. An interface 15 between the first portion 10 and the second portion 20 may be a triply periodic minimal surface (TPMS). The first portion 10 and the second portion 20 may directly contact each other. As illustrated in FIG. 1, the interface 15 may be, for example, Schoen's Gyroid Surface. It will be understood that the interface 15 can be any of triply periodic minimal surfaces including, but not limited to, a Fischer-Koch CY surface, a Schwarz diamond surface, a Schoen's I-WP Surface, or a Fischer-Koch S surface. The unit cell 50 may be an interpenetrating phase composite.

The first portion 10 may have a first volume, and the second portion 20 may have a second volume. Although FIG. 1 shows that the first volume of the first portion 10 is approximately 50% of a volume of the unit cell 50, a ratio of the first volume 10 to the volume of the unit cell 50 may vary from about 0.1% to about 99.9%. In some embodiments, the ratio of the first volume 10 to the volume of the unit cell 50 may be from about 10% to about 50%.

The first portion 10 may include a reinforcing material, and, in some embodiments, the first portion 10 may be substantially filled with a reinforcing material, as illustrated in FIG. 1. The second portion 20 may include a matrix material, and in some embodiments, the second portion 20 may be substantially filled with a matrix material as illustrated in FIG. 1. In some embodiments, each of the reinforcing material and the matrix material may include, for example, polymer, fluid (e.g., liquid or gas), metal, glass, ceramic, or composite thereof. In some embodiments, the matrix material may be different from the reinforcing material.

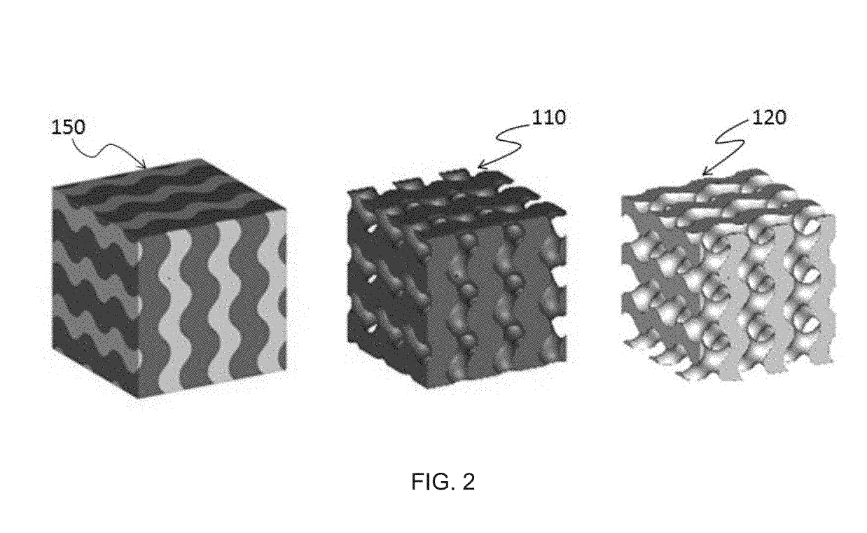

FIG. 2 illustrates an IPC structure including the unit cell of FIG. 1. Referring to FIG. 2, an interpenetrating phase composite structure 150 may include unit cells 50 that are connected to each other and are arranged in three-dimensions. The interpenetrating phase composite structure 150 may include a first structure 110 including the first portions 10 connected to each other and a second structure 120 including the second portions 20 connected to each other.

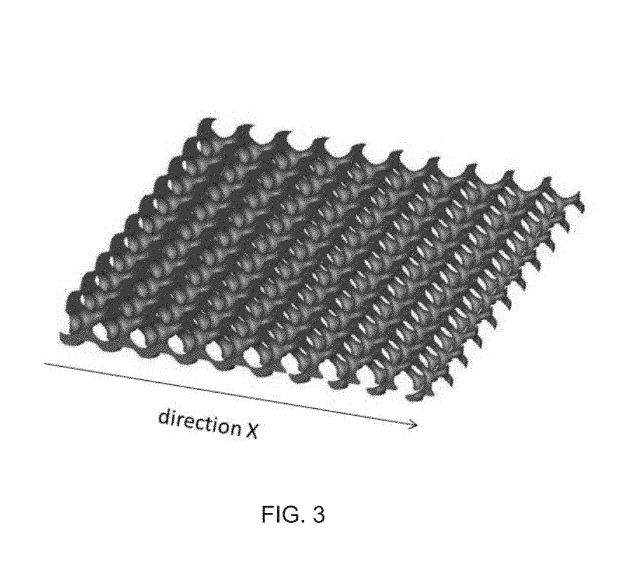

In some embodiments, the respective ratios of the first volumes to the volume of the unit cells may be different by the unit cells. In some embodiments, the respective ratios of the first volumes to the second volumes may be different by the unit cells. FIG. 3 illustrates a portion of a functionally graded IPC structure. The functionally graded WC structure of FIG. 3 includes the first portions 10 of FIG. 1. As illustrated in FIG. 3, the first volumes of the first portions 10 gradually decreases along a direction X for functional grading. Accordingly, the interpenetrating phase composite structure of FIG. 3 is referred to as a functionally graded interpenetrating phase composite structure.

The interpenetrating phase composite structures and the functionally graded interpenetrating phase composite structures may be used as or may be included in a thermal insulator, an acoustic insulator, a sound-proof material, a shock absorbing material, a three dimensional continuous battery electrodes, or a catalyst supporter.

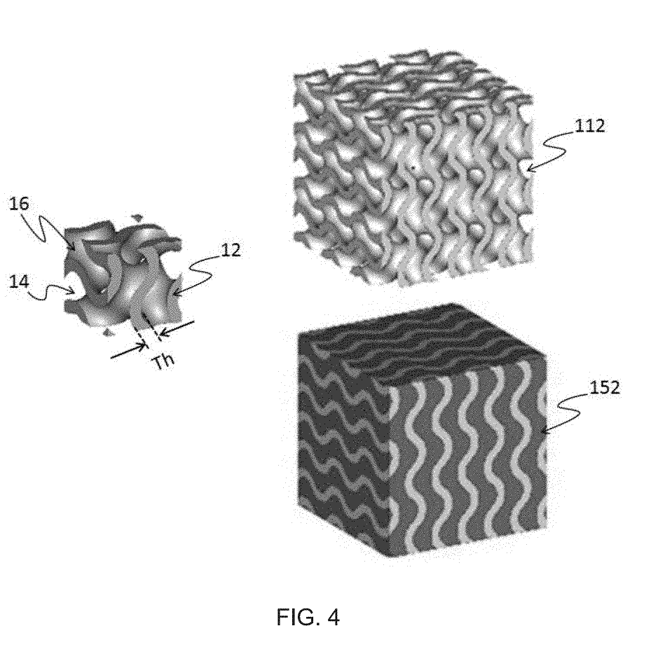

FIG. 4 illustrates a unit cell and an IPC structure including the unit cell according to some embodiments of the present invention. Referring to FIG. 4, in some embodiments, a unit cell of an interpenetrating phase composite structure may include a reinforcement phase 12 that has a curved body. The reinforcement phase 12 may divide a unit cell into a first space 14 and a second space 16. The reinforcement phase 12 may have a uniform thickness Th, as illustrated in FIG. 4. The reinforcement phase 12 may have opposing surfaces that both define a same triply periodic minimal surface pattern, such as Schoen's Gyroid Surface, as illustrated in FIG. 4. The opposing surfaces of the reinforcement phase 12 may define any of triply periodic minimal surfaces including, but not limited to, a Fischer-Koch CY surface, a Schwarz diamond surface, a Schoen's I-WP Surface, or a Fischer-Koch S surface.

The reinforcement phases 12 may be connected to each other and may be arranged in three-dimensions to provide a reinforcement structure 112. The first and second spaces 14 and 16 may be filled with a material to provide an interpenetrating phase composite structure 152. In some embodiments, the first space 14 may include a first material different from a second material included in the second space 16. The each of the first material and the second material may include, for example, polymer, fluid (e.g., liquid or gas), metal, glass, ceramic, or composite thereof. The first material may be the same as or different from the second material. In some embodiments, the reinforcement phases 12 may include a material different from the first and second materials.

In some embodiments, the thicknesses Th of the reinforcement phases 12 may be different by the unit cells. When the respective thicknesses Th of the reinforcement phases 12 gradually vary (e.g., gradually decrease) along a direction, the interpenetrating phase composite structure 152 may be referred to as a functionally graded interpenetrating phase composite structure.

According to some embodiments of the present invention, methods of forming interpenetrating phase composite structures (e.g., functionally graded interpenetrating phase composite structures) including three-dimensional triply periodic minimal surfaces (TPMSs) are provided. A first step of the methods may include using a computer-aided design (CAD) software employed to create mathematically based digital files for the three-dimensional triply periodic minimal surface (TPMS) unit cell. In a second step, a unit cell may be selected based on the intended use of the IPC structure. The unit cell may be selected to have the property of being interconnectable into a three-dimensional non-self-intersecting structure. In a third step, the interconnectable TPMS may be inputted into a solid cube structure to divide the solid cube structure into two volume phases (e.g., a reinforcement phase and a matrix phase). The triply periodic minimal surface may define an interface between the dissimilar materials of each volume. The two volumes may be identical or non-identical. In some embodiment, based on the intended use of the IPC structure, a volume fraction of a reinforcement phase may be varied for functional grading. In a fourth step, each volume partitioned by the TPMS may be assigned a material or fluid, where at least one volume phase may be a hard reinforcing material. In a fifth step, the volume phase of the hard reinforcing material may create a solid-network that interpenetrates the reinforced phase. In a sixth step, the unit cell may be patterned into a three-dimensional fitting within the structure of the intended use. In some embodiments, the third step may be performed before the second step.

According to some embodiments of the present invention, methods of forming interpenetrating phase composite structures including TPMSs may include a first step that may use a computer-aided design (CAD) software employed to create mathematically based digital files for the three-dimensional triply periodic minimal surface (TPMS) unit cell. In a second step, a unit cell may be selected based on the intended use of the IPC structure. The unit cell may have the property of being interconnectable into a three-dimensional non-self-intersecting structure. In a third step, the triply periodic minimal surface may be given a specific thickness, which is continuous and fixed throughout the surface, such that three-phase volume may be created by offsetting the triply periodic minimal surface equally in opposite directions. In a fourth step, each phase in the three-phase volume is assigned either a reinforcing material or non-reinforcing phase. The volume assigned to include a reinforcing material may be created as a hard shell-like structure that may maintain the characteristics of TPMS on both sides of the thickened surface. Opposing sides of the hard shell-like structure may define a same TPMS pattern. The non-reinforcing phase(s) may be a material or fluid. In a fifth step, the hard shell-like structure may create a sheet-network that interpenetrates the reinforced phase(s). In a sixth step, the unit cell may be patterned into a three-dimensional fitting within the structure of the intended use. In some embodiments, the third step may be performed before the second step.

According to some embodiments of the present invention, a method of producing an object including three-dimensional solid-network or sheet-network TPMS-based IPC may use additional steps of first converting or slicing the IPC structure into a two-dimensional pattern that, when stacked, forms a three-dimensional structure which can be formed using any suitable manufacturing methods. In some embodiments, 3-D printing may be used. In a second step, computer aided manufacturing may be used to produce the object. The composition of the material forming the object may be selected based on the intended use of the object. In some embodiments, the manufactured object including IPC may be tested mechanically to evaluate the mechanical properties of the structure. In some embodiments, the mechanical properties may be improved by changing the volumes of the two phases in solid-network IPC or the three phases in sheet-network IPC.

According to some embodiments of the present invention, the mechanical properties of the TPMS-based IPC may be optimized by modifying one or more elements of the first, second and third steps of the methods.

In some embodiments, each phases of TPMS-based IPC may include ceramics, polymers, fluid (e.g., liquid or gas), metals, or composites thereof.

According to some embodiments of the present invention, hybrid TMPS IPC structures may be formed. The hybrid TMPS IPC structures may include complementary solid-network structures where the total volumes occupied by the two complementary structures are less than 95%. The two complementary solid-network structures may be composed of identical or non-identical materials selected from ceramics, polymers, metals, or composites thereof. The remaining volume may be occupied by material or fluid.

In some embodiments, the phases of the IPC may be functionally graded depending on the intended application.

In some embodiments, one or all of the phases may be made of TPMS-based IPCs.

### EXAMPLE 1

### Generation of TPMS-based IPC Using Sheet-Networks and Solid-Networks Strategies

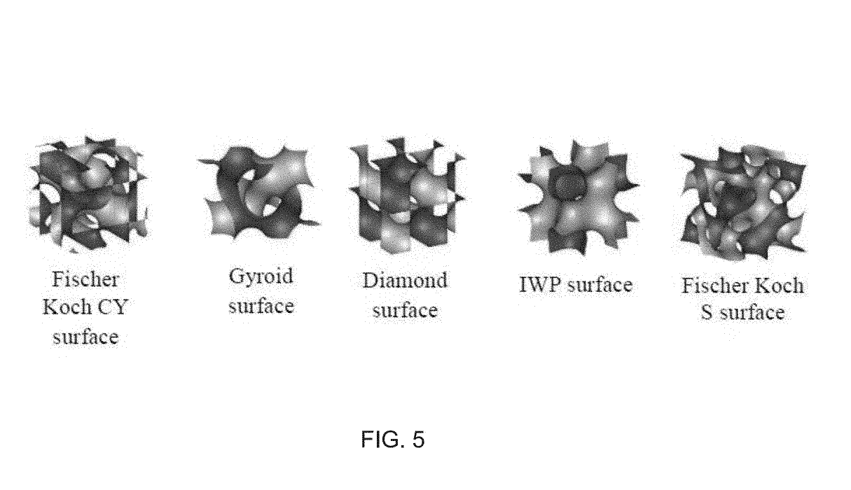

Triply periodic minimal surfaces (TPMS) structure is a structure based on the concept of minimal surfaces. This structure takes the form of a unit cell repeated in three-dimensions and form a periodic structure. The periodic structure has the advantage of being non-self-intersecting, where the structure is formed of continuous smooth curves with no edges or corners, splitting a space into maze-like spaces. Examples of periodic minimal surfaces, which are shown in FIG. 5, can be used as base structure for IPCs and include, but not limited to Schoen's I-WP Surface (IWP), Schoen's Gyroid Surface (G), Fischer-Koch S Surface (S), Schwarz diamond (D), and Fischer-Koch CY Surface (CY).

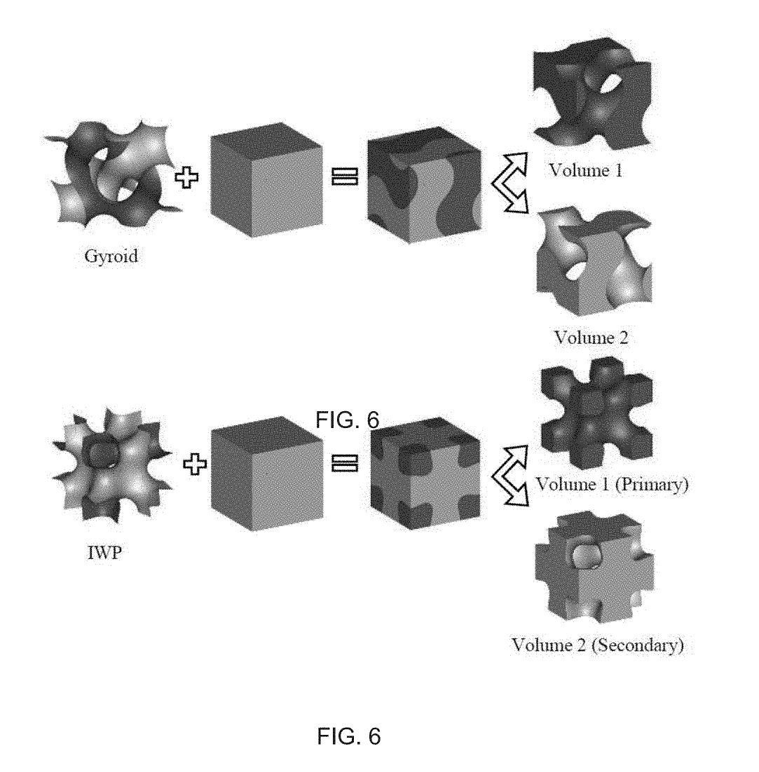

TPMS with cubic symmetries divides a space into sub-volumes that can be either identical (interchangeable) or non-identical. Examples of TPMS topologies that split the space into two identical sub volumes are Gyroid (See FIG. 6), Diamond, and Fecher Koch C(Y). Other TPMS topologies, such as IWP shown in FIG. 6, split the space into two different sub volumes. It will be understood that Diamond (D-IPC), Gyroid (G-IPC) and Fecher Koch C(Y) (CY-IPC) may form IPCs with interchangeable similar domains, and the IWP with its primary and secondary domains may form IWP-Primary (IWP-P) and IWP-secondary (IWP-S) IPCs.

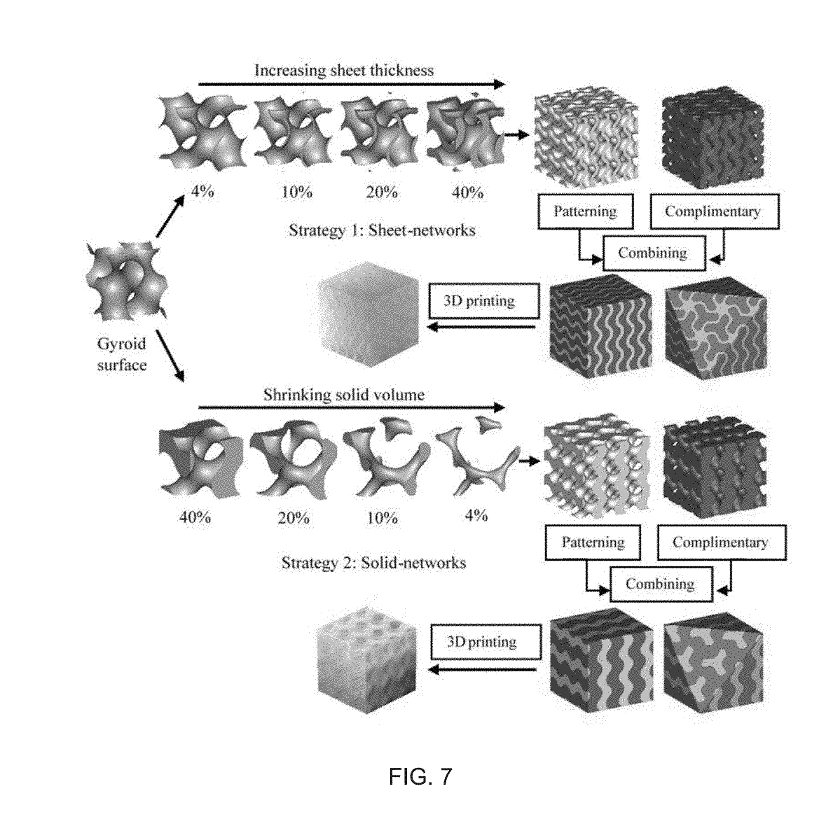

FIG. 7 represents two strategies for creating IPC structures. Referring to FIG. 7, First, a computer-aided design (CAD) software is employed to create mathematically based digital files for the desired three-dimensional triply periodic minimal surface (TPMS). These unit cells can be interconnected in a three-dimensional non-self-intersecting structure, whereby a CAD drawing is used to generate a desired periodic minimal surface.

Next, two main strategies by which a TPMS morphology can be employed to create a solid reinforcement phase for IPCs as illustrated in FIG. 7. The first strategy, the sheet-network strategy, is performed by giving the minimal surface a certain thickness, which is continuous and fixed throughout the surface, such that the volume fraction of the reinforcement phase is controlled by the specified thickness. In this strategy, the shell-like architecture is created such that the characteristics of TPMS are maintained on both sides of the thickened surface. In FIG. 7, a Gyroid sheet-network surface is shown increasing from 4% to 40% by volume.

The second strategy, the solid-network strategy, is performed by solidifying one of the volumes partitioned by the TPMS topology, where the TPMS characteristics are maintained only on the interface between the two dissimilar co-continuous phases and the volume fraction. As illustrated in FIG. 7, the solid volume may be expanded and contracted. Two volumes of the unit cell formed using solid-network strategy may include the same material or different materials.

In the next step, after the Gyroid solid-network or sheet-network IPC is created, it is patterned in three-dimensions within any desired structure or geometry as illustrated in FIG. 7. It will be understood that, in some embodiments, the TPMS surface can be patterned within the desired structure or geometry and then thickened or solidified to achieve the needed volume fraction.

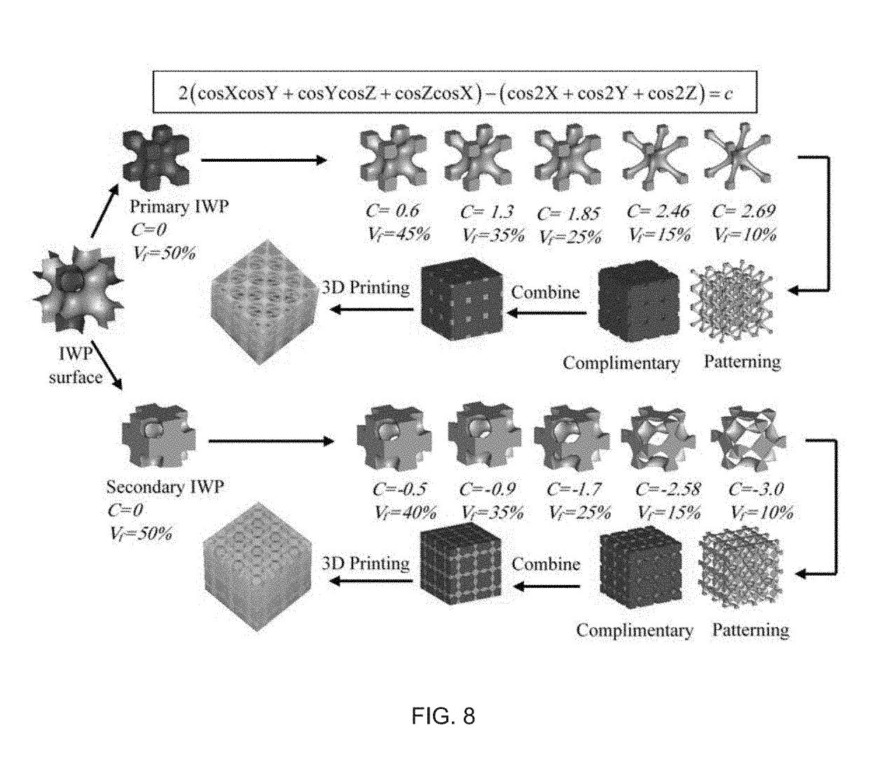

FIG. 8 represents methods of forming IPC structures. Referring to FIG. 8, IWP is used to form non-identical, complementary solid-network IPC structures. Both non-identical structures of triply periodic minimal surfaces are subjected to reducing their volumes from 50% to 10% as shown in FIG. 8, resulting in a skeleton structure that could be used for reinforcing the other material. As shown in FIG. 8, in some embodiments, the volume fraction of the two phases are controlled by c constant in the level set equation. The selection of the volume is dictated by its mechanical property and/or weight for the intended use.

It should be noted that a surprising aspect of non-identical IPC solid-network structures is that the two structures can be used as a hybrid reinforcing structure. For example, two non-identical IWP solid-network structures having 10% volume can fit together as a hybrid structure providing a three components structure that include two reinforcing structures having the same or different material that occupy a total of 20% of the volume, and the remaining 80% of the volume is occupied with another material or fluid.

After the desired TPMS-based IPC structure is selected and patterned to fit inside the desired shape, a complementary TPMS-based IPC structure is defined. Next the patterned and complementary volumes representing different material are combined to produce a physical rendition of the TPMS-based IPC, a stereo-lithography (STL) computer file is generated for the three-dimensional (3D) component which is then sliced into two-dimensional patterns and repeated to form a 3D structure. Examples of sheet-networks and solid-networks IPC are shown in FIG. 6 and FIG. 7. It should be noted that one of the volumes in either the sheet-networks or solid-networks IPC structures may be a fluid rather than a solid.

In a final step, computer aided manufacturing is employed to transform the computer aided designed file into a real product made of any desirable material. To fabricate the TPMS-based IPC the multi-material 3D printer Connex 260 (Objet Geometries, USA), which allows concurrent printing of two dissimilar materials with micrometer resolution, was employed to fabricate the IPC samples. TangoPlus (a soft rubbery material) was used as the matrix and VeroWhite (a rigid opaque photopolymer) was used as the reinforcement phase.

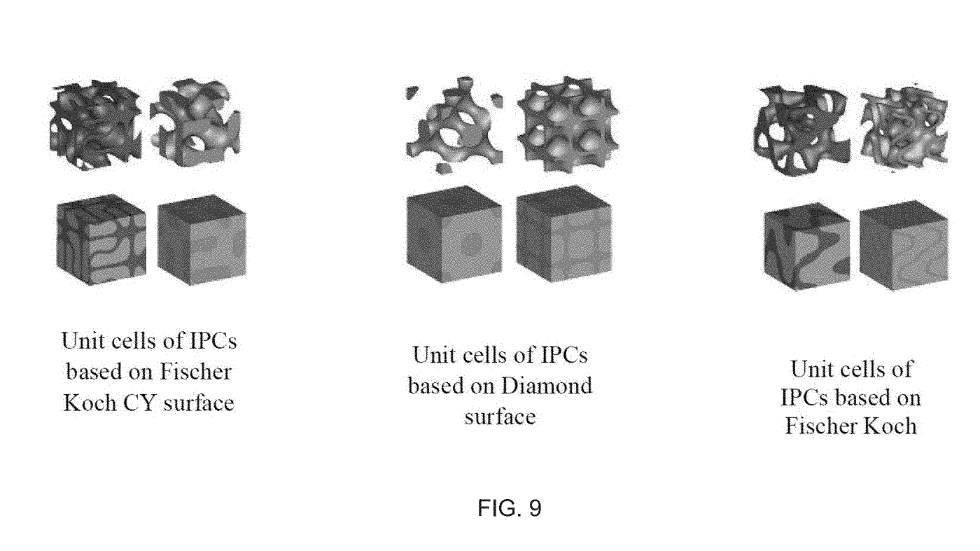

Examples of a unit cell of TPMS-based IPCs are illustrated in FIG. 9.

### EXAMPLE 2

### Testing of TPMS-based IPCs for Mechanical Properties

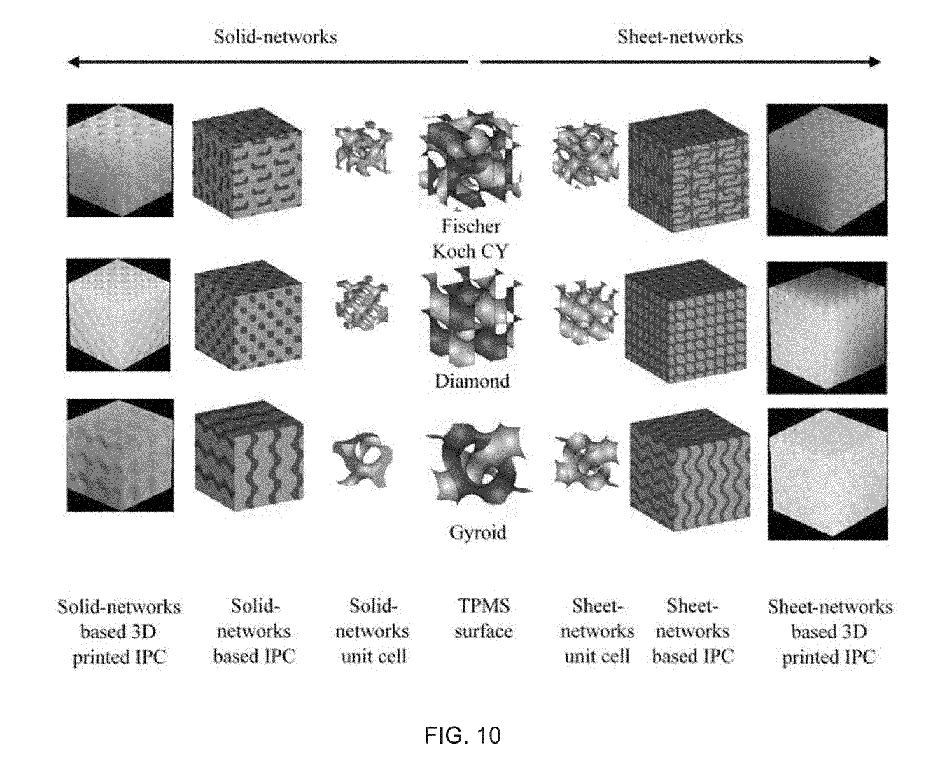

After the CAD structure are designed and made into a TPMS-based IPC structure using 3-D printing technologies, the physical model of the structure are tested for mechanical properties. Testing of TPMS structures are not limited to obtain mechanical properties and are used to optimize thermal and electrical conductivities, optimized fluid permeability, tunable acoustic attenuation and transmission, and visible photonic crystal properties. In fact, the selection of the geometrical characteristics of TPMS-based IPC structures and compositions with new mechanical, thermal, electrical, acoustic and photonic properties are possible using these methods described in this disclosures. Examples of CAD drawing of TPMS surfaces and printed materials are shown in FIG. 10.

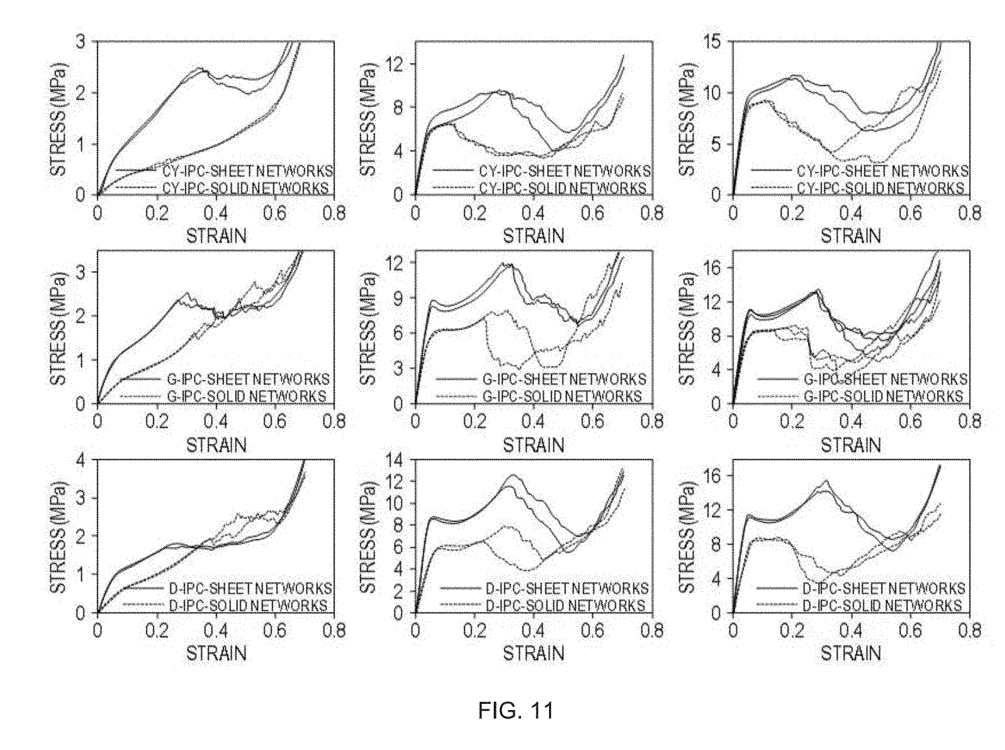

FIG. 11 is graphs of stress-strain curves of IPCs. FIG. 11 shows stress-strain curves for the solid-networks and sheet-networks IPC structures having three different volume fractions, 10% (graphs in the first column), 35% (graphs in the second column) and 40% (graphs in the third column), of the hard reinforcement phase. Each graph shows two different stress-strain diagrams, where each diagram compares the mechanical performances of IPC retaining sheet-networks reinforcement against IPC retaining solid-networks reinforcement. Two samples of each composite are tested to show test repeatability.

A stress-strain curve is a curve showing results of a test done on samples (in our case, cubical samples of interpenetrating phase composites.) in which the cubical sample is compressed using a certain controlled displacement, and the resistance (reaction force) of the sample is measured.

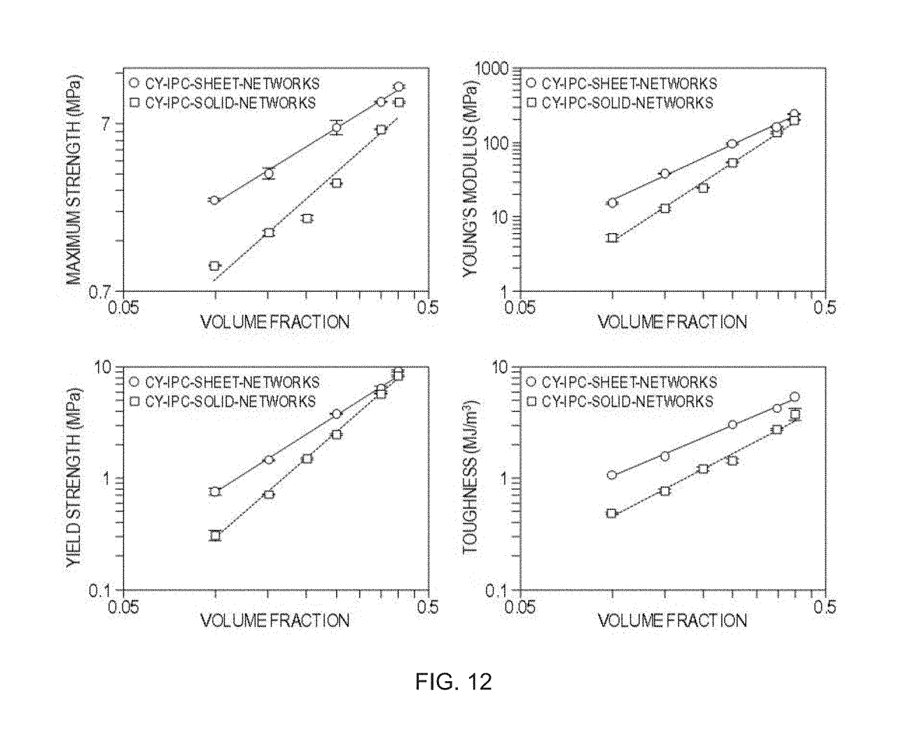

FIGS. 12, 13 and 14 are graphs of mechanical properties of IPCs. In FIG. 12, the Fischer Koch CY Surface was employed to create solid-networks IPC and sheet-networks IPC, fabricated using 3D printing technology, and tested in compression using a universal testing machine (Instron) in controlled strain rate of 0.001/s along the printing direction. The results showed that a sheet-network IPC performs mechanically better than solid-network IPC in terms of Young's modulus, maximum strength, yield strength and toughness measured until densification strain. The results shown in FIG. 12 are extracted from stress-strain responses.

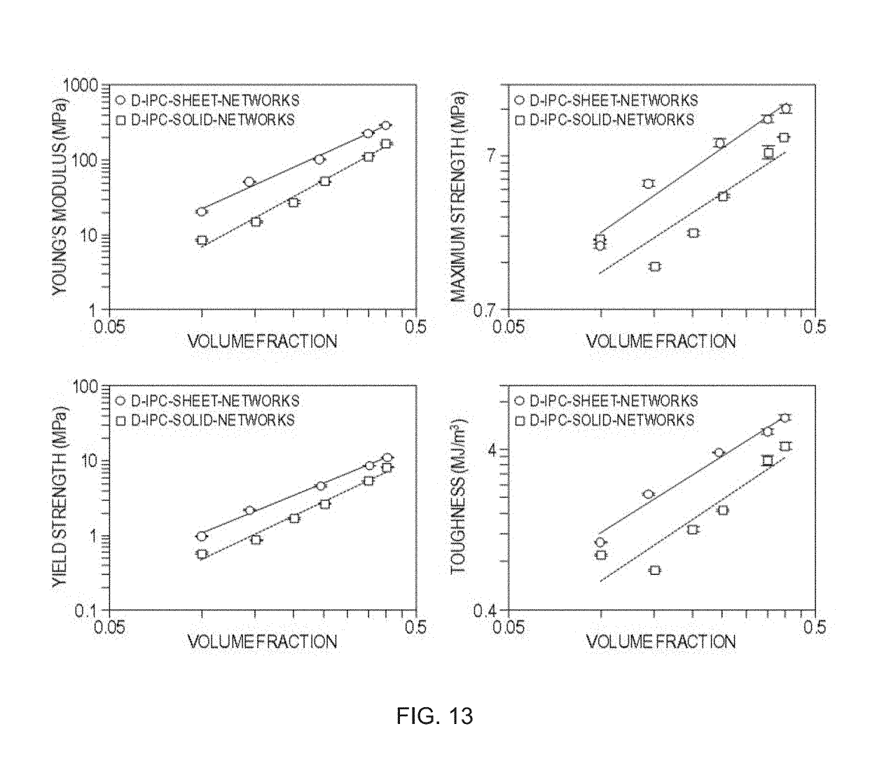

In FIG. 13, the Schwarz Diamond (D) Surface was employed to create solid-networks IPC and sheet-networks IPC, fabricated using 3D printing technology, and tested in compression using a universal testing machine (Instron) in controlled strain rate of 0.001/s along the printing direction. The results showed that a sheet-network IPC performs mechanically better than solid-network IPC in terms of Young's modulus, maximum strength, yield strength and toughness measured until densification strain. The results shown in FIG. 13 are extracted from stress-strain responses.

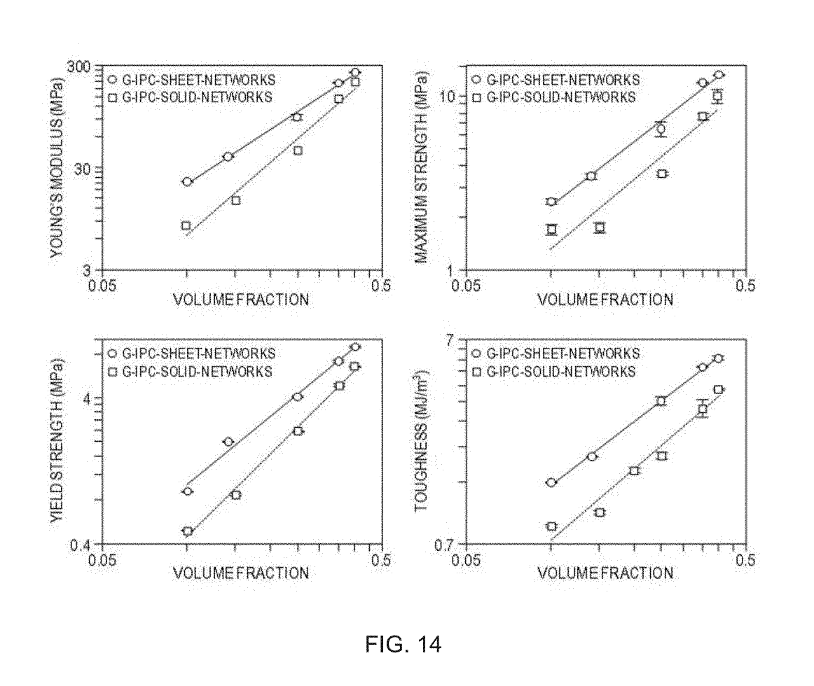

In FIG. 14, the Gyroid (G) Surface was employed to create solid-networks IPC and sheet-networks IPC, fabricated using 3D printing technology, and tested in compression using a universal testing machine (Instron) in controlled strain rate of 0.001/s along the printing direction. The results showed that a sheet-network IPC performs mechanically better than solid-network IPC in terms of Young's modulus, maximum strength, yield strength and toughness measured until densification strain. The results shown in FIG. 14 are extracted from stress-strain responses.

### EXAMPLE 3

### Production of Jet Engine Bracket using TPMS-based IPC Structures

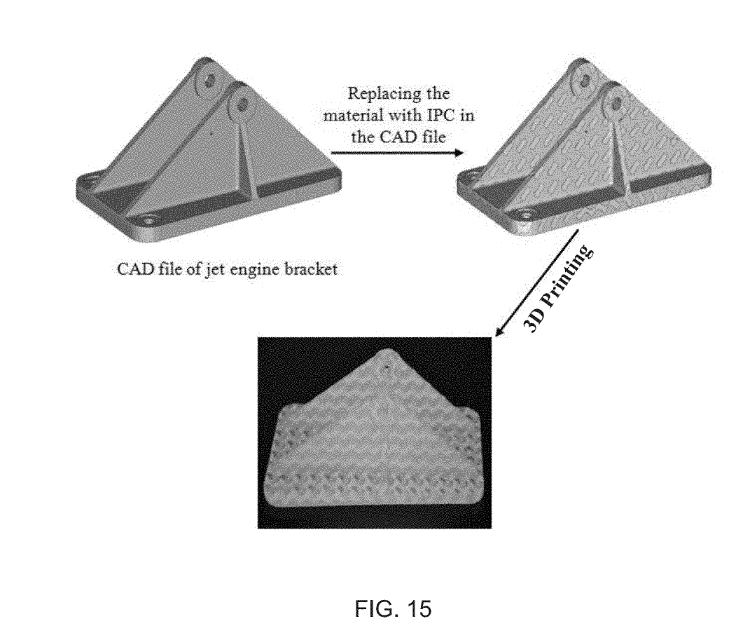

The TPMS-based IPC structures technology is not restricted to cube structures and can be used to form objects having various shapes, such as, a jet engine bracket illustrated in FIG. 15. Referring to FIG. 15, first, CAD file of a jet engine bracket may be produced. Next, the CAD was configured with a Gyroid TPMS-based IPC structure solid-network using a 40% volume fraction. Finally, the TPMS-based IPC was fabricated using a multi-material 3D printer Connex 260 (Objet Geometries, USA) and the final fabricated product is shown in the bottom of FIG. 15.

### EXAMPLE 4

### Creating TPMS-based IPC Cores for Sandwich Panels

Sandwich panels type structure is a structure including sheet materials, which are made of metal, polymer, ceramic, or composites thereof and extend parallel each other, and the gap between the sheets is filled with a core material, which is made of metal, plastic, ceramic, or composites thereof.

The core material can be made of any type of material preferably with a high strength to weight ratio.

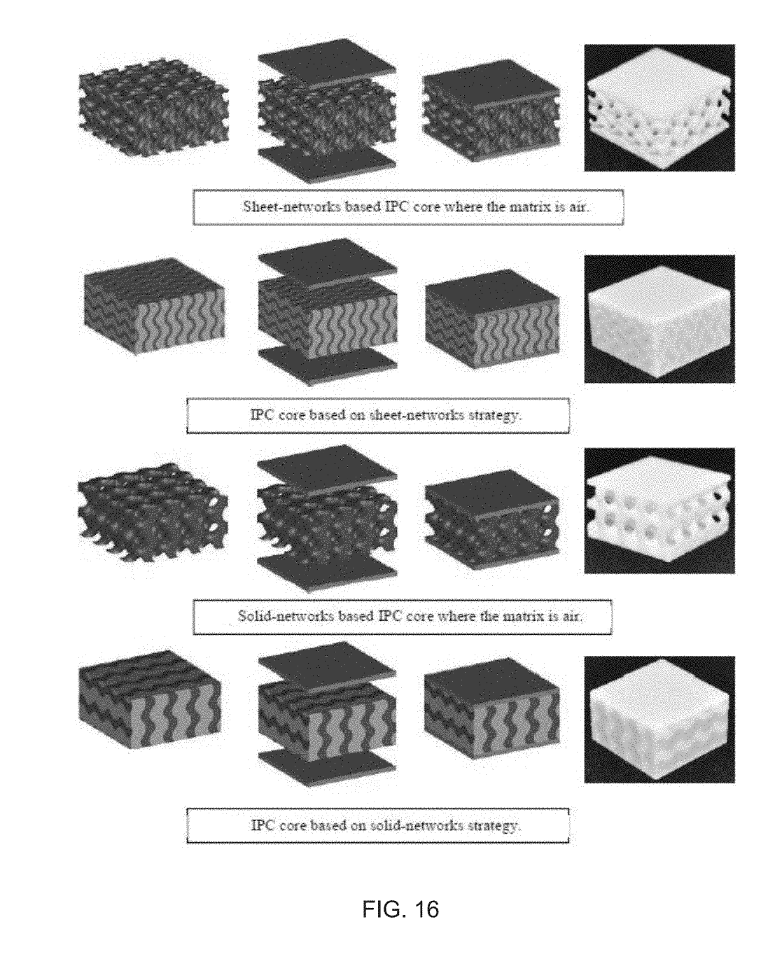

FIG. 16 illustrates sandwich panels with TPMS-based IPC cores according to some embodiments of the present invention. Referring to FIG. 16, sandwich panels are created with cores made of IPC material. The IPCs can be made using the sheet-networks strategy as shown in top two rows of FIG. 16 or using the solid-networks strategy as shown in bottom two rows of FIG. 16. All cores shown in FIG. 16 include one of the phases of the IPC that include air.

### EXAMPLE 5

### Creating Functionally Graded IPC

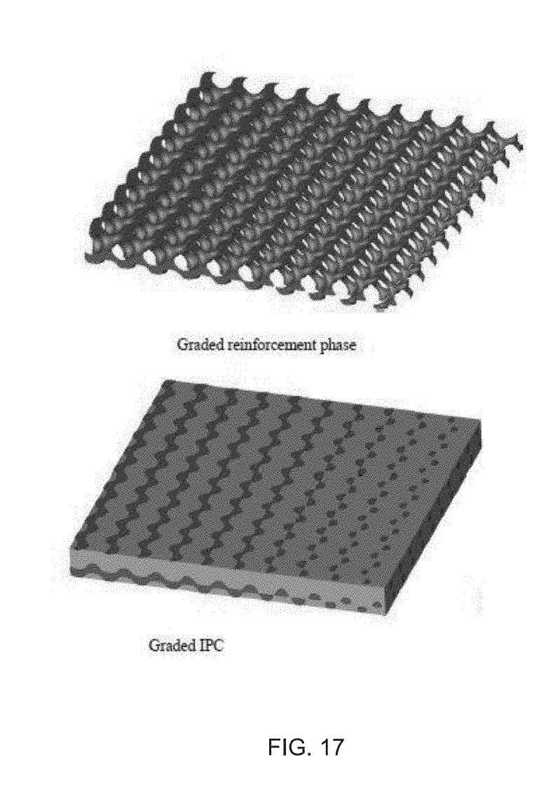

FIG. 17 illustrates a functionally graded IPC. Referring to FIG. 17, one of the phases of the IPC can be functionally graded depending on the intended application.

### EXAMPLE 6

### Making IPCs Where One or More of the Phases is Made of IPC Material

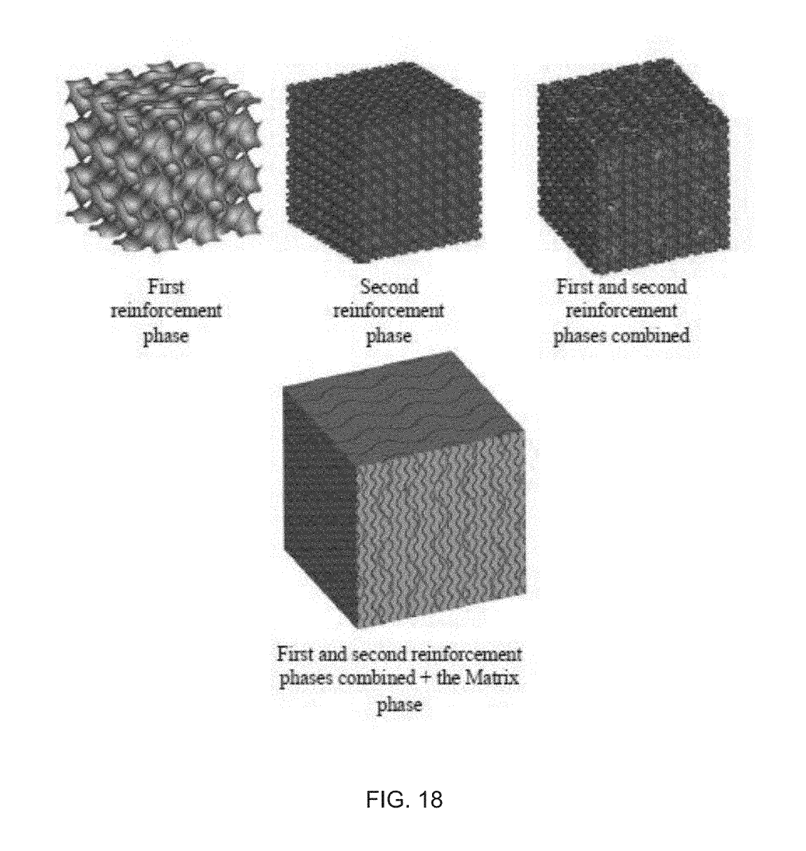

According to some embodiments of the present invention, either and/or all of the phases can be a TPMS-based IPC. FIG. 18 illustrates an IPC including two reinforcement phases. Referring to FIG. 18, the matrix phase is made of IPC and the reinforcement phase is a sheet-networks based TPMS structure. It will be understood that the patterned structure may be functionally graded depending on the intended application.

### EXAMPLE 7

### Making 3D Interpenetrating Phases Battery Electrodes

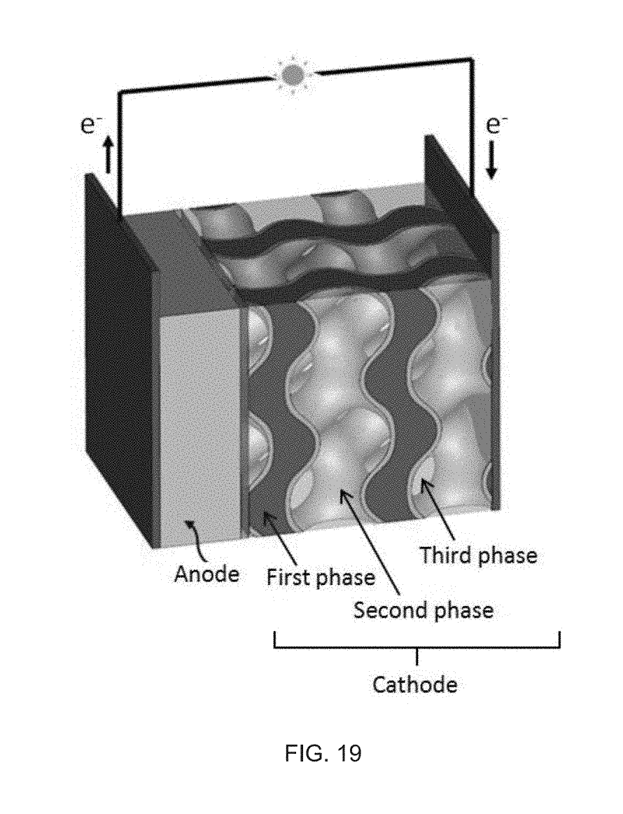

FIG. 19 illustrates a battery including an interpenetrating phase cathode. The cathode is made of a three-phase interpenetrating phase composite. In the three-phase interpenetrating phase composite, the first phase can be a conductive material, the second phase can be an electrolytically active phase, the and the third phase (transparent) can be the electrolyte material.

The above-disclosed subject matter is to be considered illustrative, and not restrictive, and the appended claims are intended to cover all such modifications, enhancements, and other embodiments, which fall within the true spirit and scope of the inventive concept. Thus, to the maximum extent allowed by law, the scope is to be determined by the broadest permissible interpretation of the following claims and their equivalents, and shall not be restricted or limited by the foregoing detailed description.

What is claimed is:

1. A functionally graded interpenetrating phase composite structure comprising:
a plurality of unit cells that are connected to each other and are arranged in three-dimensions,
wherein each of the plurality of unit cells comprises an interpenetrating phase composite that consists of a first portion having a first volume and a second portion having a second volume,
wherein the first portion of the interpenetrating phase composite is substantially filled with a reinforcing material,
wherein a surface of the reinforcing material facing the second portion of the interpenetrating phase composite comprises a triply periodic minimal surface, and
wherein a first one of the plurality of unit cells has a first ratio of the first volume to the second volume, a second one of the plurality of unit cells has a second ratio of the first volume to the second volume, and the first ratio and the second ratio are different from each other.

2. The functionally graded interpenetrating phase composite structure of claim 1, wherein the reinforcing material comprises from about 0.1% to about 99.9% of a volume of each of the plurality of unit cells.

3. The functionally graded interpenetrating phase composite structure of claim 1, wherein the triply periodic minimal surface is a Fischer-Koch CY surface, a Schoen's Gyroid Surface, a Schwarz diamond surface, a Schoen's I-WP Surface, or a Fischer-Koch S surface.

4. functionally graded interpenetrating phase composite structure of claim 1, wherein the second portion of the interpenetrating phase composite comprises a matrix material, and
wherein each of the reinforcing material and the matrix material comprises polymer, metal, liquid, gas, glass, ceramic, or composite thereof.

5. The functionally graded interpenetrating phase composite structure of claim 4, wherein the matrix material is different from the reinforcing material.

6. The functionally graded interpenetrating phase composite structure of claim 4, wherein the second portion of the interpenetrating phase composite is substantially filled with the matrix material.

7. The functionally graded interpenetrating phase composite structure of claim 1, wherein the interpenetrating phase composite structure comprises a thermal insulator, an acoustic insulator, a sound-proof material, a shock absorbing material, a three dimensional continuous battery electrodes, or a catalyst supporter.

8. A functionally graded interpenetrating phase composite structure comprising:
a plurality of unit cells that are connected to each other and are arranged in three-dimensions,
wherein each of the plurality of unit cells comprises an interpenetrating phase composite that comprises a reinforcement phase having a curved body that divides each of the of the plurality of unit cells into a first space and a second space,
wherein the reinforcement phase comprises opposing surfaces that both define a same triply periodic minimal surface pattern, and
wherein the curved body of a first one of the plurality of unit cells has a first thickness, and the curved body of a second one of the plurality of unit cells has a second thickness that is different from the first thickness.

9. The functionally graded interpenetrating phase composite structure of claim 8, wherein the curved body of the reinforcement phase of each of the plurality of unit cells has a uniform thickness.

10. The functionally graded interpenetrating phase composite structure of claim 8, wherein the first space of each of the of the plurality of unit cells comprises a first material, and the second space of each of the of the plurality of unit cells comprises a second material, and the reinforcement phase comprises a third material, and
wherein each of the first, second and third materials comprises polymer, liquid, gas, metal, glass, ceramic, or composite thereof.

11. The functionally graded interpenetrating phase composite structure of claim 10, wherein the third material is different from the first and second materials.

12. The functionally graded interpenetrating phase composite structure of claim 10, wherein the first material is different from the second material.

13. The functionally graded interpenetrating phase composite structure of claim 8, wherein the triply periodic minimal surface is a Fischer-Koch CY surface, a Schoen's Gyroid Surface, a Schwarz diamond surface, a Schoen's I-WP Surface, or a Fischer-Koch S surface.

14. The functionally graded interpenetrating phase composite structure of claim 8, wherein the interpenetrating phase composite structure comprises a thermal insulator, an electrical insulator, a sound-proof material, a shock absorbing material, a three dimensional continuous battery electrodes, or a catalyst supporter.
